(19) United States
(12) Patent Application Publication
(10) Pub. No.: US 2022/0107923 A1
(43) Pub. Date: Apr. 7, 2022

(54) Taxonomy Normalization for Applications of a Remote Network Management Platform

(71) Applicant: ServiceNow, Inc., Santa Clara, CA (US)

(72) Inventors: Satyanarayana Chittiprolu, Hyderabad (IN); Sai Teja Chinthoti, Hyderabad (IN); Santhosa Srinivas Vaddadi, Hyderabad (IN); Vaisakh Krishnan, Hyderabad (IN); Ayush Aggarwal, Hyderabad (IN); Goutham Anumolu, Hyderabad (IN); Hemant Kediyal, Hyderabad (IN)

(21) Appl. No.: 17/064,067

(22) Filed: Oct. 6, 2020

(51) Int. Cl. G06F 16/21; G06F 16/28

(52) U.S. Cl. CPC G06F 16/212; G06F 16/288

(57) ABSTRACT

Persistent storage may contain a plurality of associations, including an association between: (i) a data source, (ii) an original path appearing in units of structured data generated by the data source, (iii) an original term that is a value linked to the original path, and (iv) a common term from a taxonomy that is normalized across multiple data sources. One or more processors may be configured to: receive, from the data source, a unit of the structured data; determine that an element in the unit of the structured data contains the original path and the original term as appearing in the association; associate the common term with the element; and perform an action that is triggered by the common term being associated with the element and also by one or more additional terms appearing in other elements of the unit of the structured data.

### BACKGROUND

Remote network management platforms contain computing infrastructure in data centers, and thereby provide cloud-based services to enterprises and other entities. These services may include applications that execute on the remote network management platforms and facilitate operations related to an enterprise and/or its managed network. In some cases, information used by such applications is periodically or from time to time updated by way of data feeds from the operator of the remote network management platform, the enterprise, or third parties. The updates are often text-based, in that they modify the text that is processed by the applications. But various sources of updates may provide the text using different taxonomies, leading to inconsistencies in terminology and potentially altering the operation of the applications in unforeseen ways.

### SUMMARY

The embodiments herein overcome these and potentially other challenges by introducing a systematic approach to providing a common taxonomy for applications of a remote network management platform. In particular, a number of associations may be made between original terms in structured data received from different data sources and common terms of a normalized taxonomy that are actually used by the applications. These common terms may be used by the applications in their day-to-day operations, including to trigger various actions taken by the applications. Using the normalized taxonomy avoids having to program routines or scripts to specifically recognize each of possibly many different original terms across multiple data sources and determine whether these original terms trigger the actions or modify the operations of the actions.

Accordingly, a first example embodiment may involve persistent storage containing a plurality of associations, including an association between: (i) a data source, (ii) an original path appearing in units of structured data generated by the data source, (iii) an original term that is a value linked to the original path, and (iv) a common term from a taxonomy that is normalized across multiple data sources. The first example embodiment may also include one or more processors configured to: receive, from the data source, a unit of the structured data; determine that an element in the unit of the structured data contains the original path and the original term as appearing in the association; possibly in response to determining that the element contains the original path and the original term, associate the common term with the element; and perform an action that is triggered by the common term being associated with the element and also by one or more additional terms appearing in other elements of the unit of the structured data.

A second example embodiment may involve receiving, by one or more processors and from a data source, a unit of structured data, wherein persistent storage contains a plurality of associations, including an association between: (i) the data source, (ii) an original path appearing in units of the structured data generated by the data source, (iii) an original term that is a value linked to the original path, and (iv) a common term from a taxonomy that is normalized across multiple data sources. The second example embodiment may also involve determining, by the one or more processors, that an element in the unit of structured data contains the original path and the original term as appearing in the association. The second example embodiment may also involve, possibly in response to determining that the element contains the original path and the original term, associating, by the one or more processors, the common term with the element. The second example embodiment may also involve performing, by the one or more processors, an action that is triggered by the common term being associated with the element and also by one or more additional terms appearing in other elements of the unit of structured data.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6A depicts an application supporting multiple taxonomies, in accordance with example embodiments.

FIG. 6B depicts an application supporting a common, normalized taxonomy, in accordance with example embodiments.

FIG. 7 depicts the structure of a JAVASCRIPT® Object Notation (JSON) file, in accordance with example embodiments.

FIG. 8A depicts a JSON file, its path structure, and a functionally equivalent XML file, in accordance with example embodiments.

FIG. 8B depicts a document object model (DOM) representation of the JSON file, in accordance with example embodiments.

FIG. 9 depicts a table that can be used for taxonomy normalization, in accordance with example embodiments.

FIG. 10 is a flow chart, in accordance with example embodiments.

FIG. 11 depicts a graphical user interface, in accordance with example embodiments.

FIG. 12 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

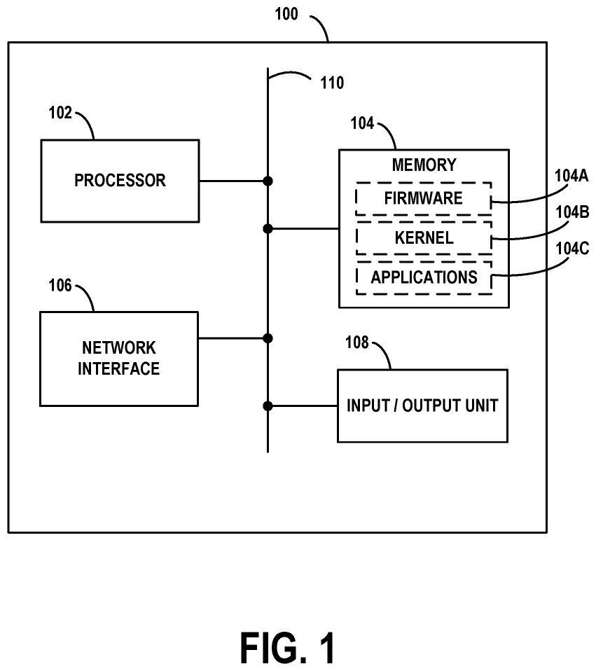

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

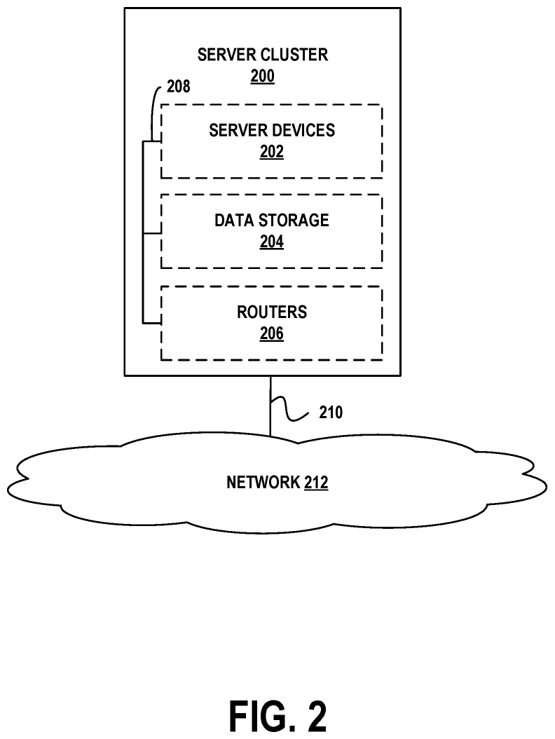

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. EXAMPLE REMOTE NETWORK MANAGEMENT ARCHITECTURE

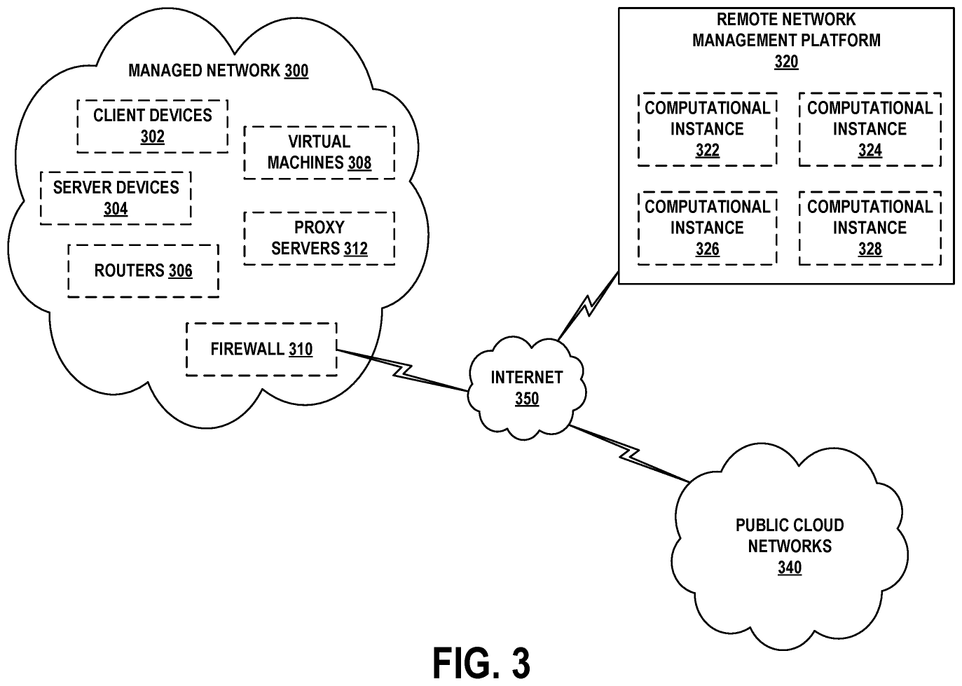

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

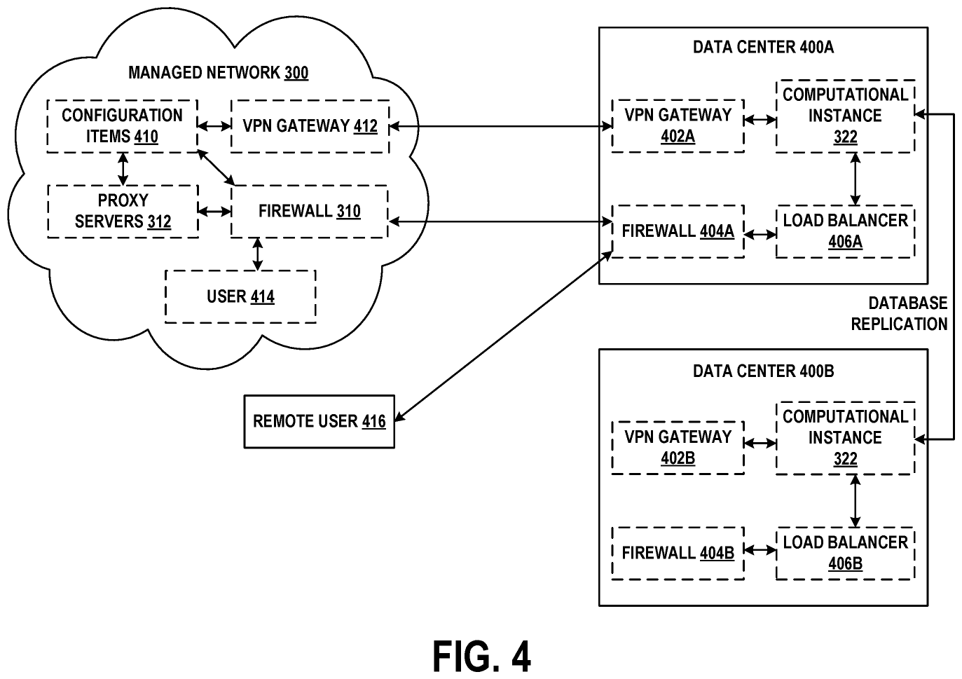

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

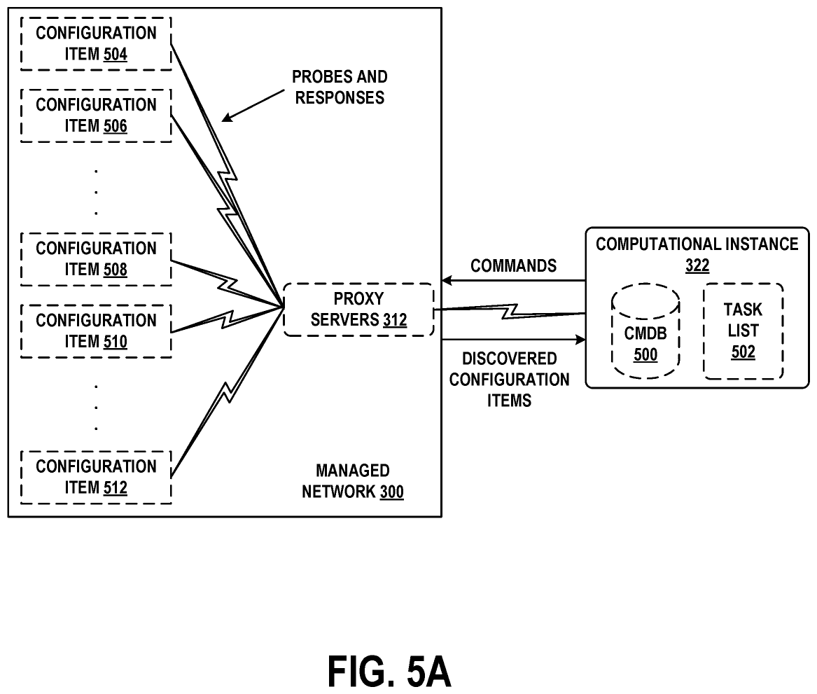

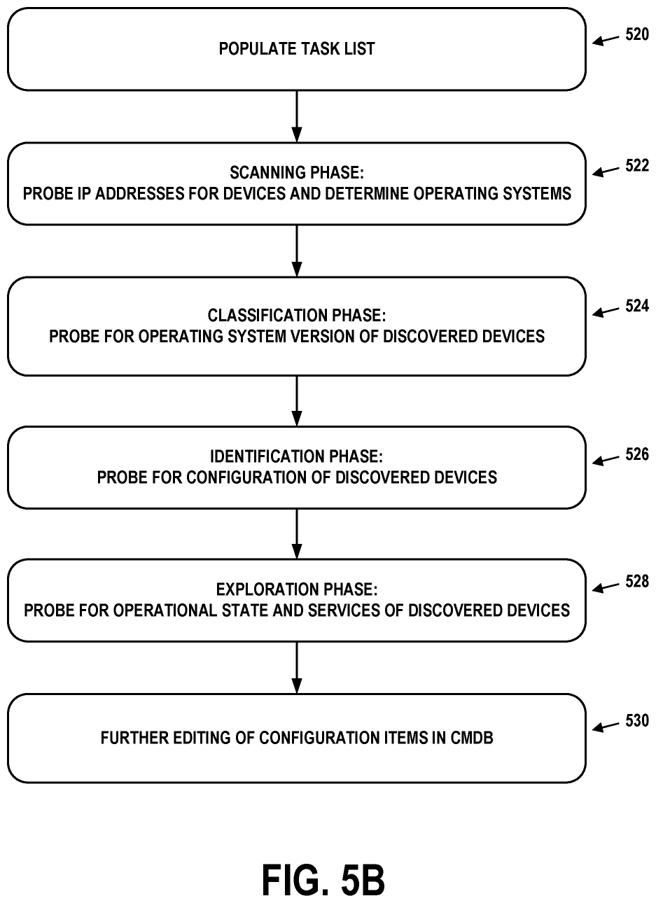

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. COMMON TAXONOMIES FOR APPLICATIONS

As noted, each computational instance of remote network management platform 320 may support a number of applications that facilitate various types of operations that are important to an enterprise and its managed network. These operations may relate to IT, security, HR, risk management, supply chain management, and other activities carried out by the enterprise.

Some of the applications may involve receiving and processing large amounts of textual data. For some enterprises, thousands of IT incident reports may be received and addressed in a given week or month. Likewise, HR data may include names, addresses, and identifying information for large number of employees. Risk management data may specify legal regulatory recommendations or requirements. In some cases, this data is location-specific, date-specific, and/or persona-specific.

Regardless of the application's goal or the exact textual data used thereby, the application may ingest this data periodically or from time to time and make decisions based on this data. The data may be locally-generated or come from external third-party sources. The decisions may trigger certain actions, such as notifying certain users, initiating or continuing workflows, or changing the state of information in a database of the enterprise's computational instance.

Challenges arise when one or more third parties supply textual data or updates thereto in different taxonomies. For example, some of these third parties may use different terms or synonyms to refer to the same concept. For example, various third parties may use the terms “America”, “United States”, or “US” to refer to the United States of America. Likewise, these third parties may also use the terms “United Kingdom”, “UK”, and “Britain” to refer to the United Kingdom of Great Britain and Northern Ireland. Many other such taxonomical disparities exist.

Supporting these different taxonomies is important, because the application may rely on certain terms to trigger actions. For instance, certain updates may cause the sending of an email to all employees of a certain region requesting that they fill out a web form. In the case of the region being the United States of America, this would require that relevant instances of “America”, “United States”, or “US” being able to trigger the action for users in that region.

But naively supporting these different taxonomies does not scale. As many third party data providers may exist, the triggers would have to be specifically encoded or configured for different terms used by each data source, and possibly updated as new taxonomies are supported. Further, multiple actions may be triggered by the terms. This leads to situations in which m different taxonomies from m different data providers are being configured for each of n triggers. As a result, a total of m×n configurations are needed, a complex arrangement that rapidly becomes impractical to manage.

Further, some applications may rely on machine learning models that were trained using only certain terms, which may not include all of the synonyms of these terms. Thus, the utility of these models may be thwarted by lack of a common taxonomy.

In short, attempting to support multiple taxonomies from multiple data sources in a simple and conventional fashion does not scale and can cause aspects of applications on remote network management platform 320 to work in a sub-optimal fashion or not work at all.

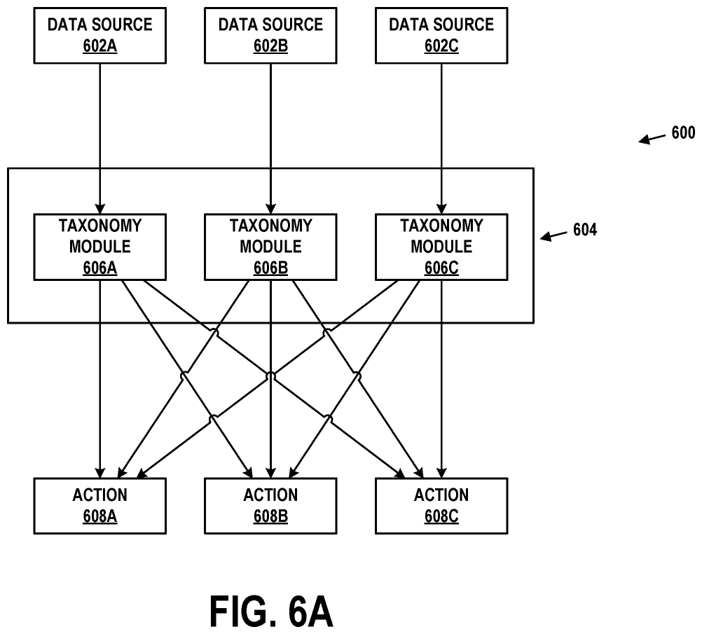

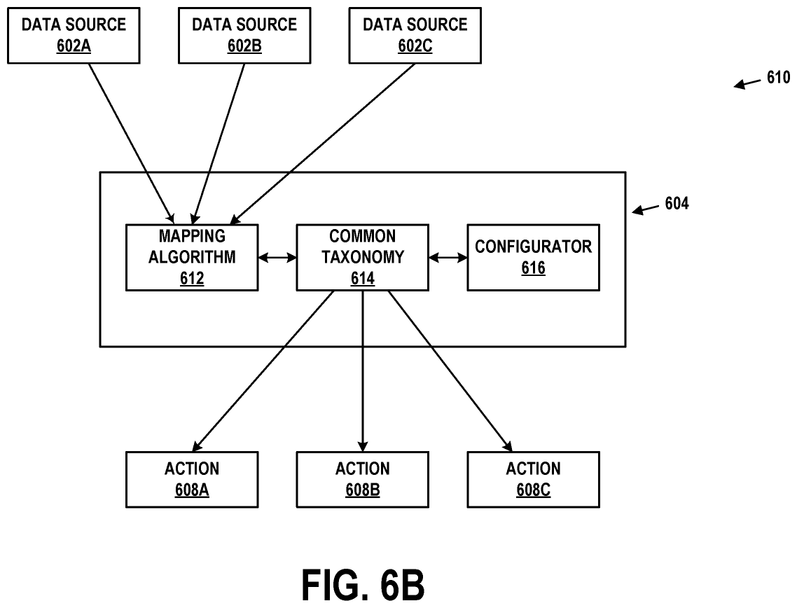

To further illustrate the difficulties related to supporting multiple taxonomies, architecture 600 of FIG. 6A is provided. In architecture 600, application 604 is configured to execute on a computational instance of remote network management platform 320. Application 604 may be any type of application that facilitates operations of an enterprise and/or its managed network (e.g., IT, security, HR, risk management, supply chain management).

Application 604 receives data from data sources 602A, 602B, and 602C. These data sources may provide data related to computer and network security vulnerabilities, enterprise risk management, IT service management, IT operations management, customer service management, etc.

As shown, each of data sources 602A, 602B, and 602C may provide its data using corresponding taxonomies that are received into application 604 by way of taxonomy modules 606A, 606B, and 606C, respectively. Data sources 602A, 602B, and 602C may be internal to remote network management platform 320, internal to the managed network of the enterprise, or external to both of remote network management platform 320 and the managed network. In some cases, data sources 602A, 602B, and 602C may be operated by third parties that supply the respective data.

The respective links between data source 602A and taxonomy module 606A, data source 602B and taxonomy module 606B, as well as data source 602C and taxonomy module 606C may support various types of interfaces and protocols. For instance, any of these links may be really simple syndication (RSS) feeds in which a taxonomy module requests updates from a data source, secure file transfer protocol (SFTP) interfaces in which a taxonomy module logs on to a data source and downloads one or more files of data, representational state transfer (REST) interfaces through which data sources can push (or otherwise provide) data, and so on. In some cases, a data source may provide a file containing the data, such as an XML file or comma-separated-value (CSV) file, and a user may manually upload this file to the computational instance.

The data may be textual in nature (or largely textual with some non-textual content), and accompanied by metadata specifying characteristics of the data. For example, data received from data source 602A may include a text file, still images, and metadata. The metadata can be in a varied of structured formats, such as XML, JAVASCRIPT® Object Notation (JSON), Yet Another Markup Language (YAML), CSV, or in a flat text format. The embodiments herein are largely focused on parsing and processing terms within the metadata, but may make use of terms in other parts of the data as well.

In application 604, taxonomy modules 606A, 606B, and 606C may each be configured to process data according to a particular taxonomy that may be specific to a data source. Thus, for instance, taxonomy module 606A is configured to process data according to a taxonomy of data source 602A, taxonomy module 606B is configured to process data according to a taxonomy of data source 602B, taxonomy module 606C is configured to process data according to a taxonomy of data source 602C.

Further, based on the results of processing the data from any of the data sources, one or more of actions 608A, 608B, and 608C may be triggered. These actions may involve transmitting information to a user (e.g., via email, text message, and/or phone call), changing the state of one or more entries in a database (such as CMDB 500), or initiating a workflow.

Notably, architecture 600 suffers from the scaling problem discussed above. Three taxonomy modules are needed, one for each data source. These taxonomy modules may include program logic (or other mechanisms) to determine which of actions 608A, 608B, and 608C are to be triggered based on the content of the data received from the respective data source. Since there are three actions in FIG. 6A, each taxonomy module contains program logic to trigger each of these actions as required. Thus, a total of nine units of custom program logic has to be developed, tested, and maintained. Moreover, if a new data source is added, then a fourth taxonomy module would have to be developed for that data source and customized for each action. Clearly, this is not a desirable arrangement.

Architecture 610 of FIG. 6B provides improvements to architecture 600 through a common, normalized taxonomy for certain terms used by application 604. Notably, a user may establish common taxonomy 614 through use of configurator 616. Then, as data is received from data sources 602A, 602B, and 602C, mapping algorithm 612 determines, based on common taxonomy 614, whether to translate certain terms in the data into their respective common terms (if such common terms exist). When such a term is translated, the triggering of any of actions 608A, 608B, and 608C may be based on the translated term (the version of the term in common taxonomy) rather than the original version of the term. As a consequence, there no longer needs to be m×n configurations for m different taxonomies and n triggers—instead, there are m mappings in mapping algorithm 612 and n triggers are each configured to use common taxonomy 614. Herein, translation may refer to associating the common term with the original term and/or replacing the original term with the common term.

In some embodiments, mapping algorithm, 612, common taxonomy 614, and/or configurator 616 may exist outside of and independently from application 604. Thus, mapping algorithm, 612, common taxonomy 614, and/or configurator 616 may be used by multiple applications. The arrangement of FIG. 6B should be interpreted to indicate that application 604 may be configured to use and/or interact with mapping algorithm, 612, common taxonomy 614, and/or configurator 616.

Common taxonomy 614 may associate a common term with one or more “synonymous” original terms. In some cases, a given common term may be associated with a different set of original terms per data source, and in other cases, the original terms may apply to all data sources. For example, suppose that data source 602A uses the terms “America” and “United States”, while data source 602B uses the term “US”. Common taxonomy 614 may be configured to indicate that the term “U.S.” should be used in place of all three of these terms.

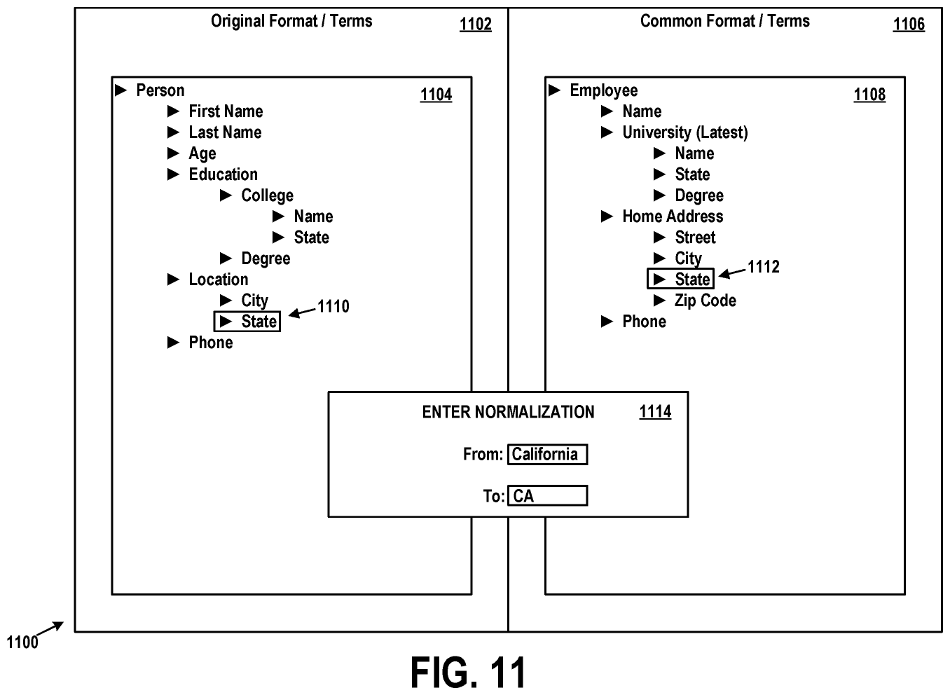

Configurator 616 may be a web-based user interface that allows a user to establish entries in common taxonomy 614. For example, this could take the form of a pair of menus that allow the user to associate a term from a particular data source to a common term in common taxonomy 614. The content of these menus may be manually configured or based on example files uploaded to the computational instance. The user may be able to add, remove, and edit entries by way of these menus. An example graphical user interface of configurator 616 is shown in FIG. 11.

Mapping algorithm 612 is program logic that executes on data received from a data source. Particularly, mapping algorithm 612 identifies associations in common taxonomy 614 and translates affected original terms in the data to their common versions.

FIG. 6B contains a high-level description of architecture 610 for purposes of illustration. More details are provided regarding the functionality of mapping algorithm 612, common taxonomy 614, and configurator 616 with concrete examples below. But in order to make this example concrete, a brief diversion into structured data formats is provided.

### VI. EXAMPLE STRUCTURED DATA FORMATS

Many markup languages, such as XML, HTML, and JSON, represent textual information as structured data. In general, the structured data takes form of individual elements, each of which may be primitives (e.g., type-value pairs), arrays, or objects. As arrays and objects can contain primitives as well as other arrays and/or objects, the structured data may be nested in an arbitrarily deep fashion. Any element in the structured data may be uniquely addressable by way of a path that specifies the nesting of zero or more arrays or objects encapsulating the element.

A document object model (DOM) refers to a tree or tree-like in-memory representation of a unit of a markup language (e.g., XML, HTML, or JSON). For example, a JSON file may be read into short-term storage (e.g., volatile memory such as main memory) from long-term storage (e.g., non-volatile memory such as a hard disk or solid state disk) or from a network connection. The JSON file may be parsed and stored in a DOM format in the short-term storage. Storing the information as a DOM facilitates searches thereof due to the DOM's tree-like structure.

As an example of a structured data format, JSON supports recursive hierarchical nesting of objects and arrays. A JSON object is an unordered set of key-value pair elements that begins with a left brace (“{”) and ends with a right brace (“}”). Each key-value pair element in an object is separated by a comma. JSON arrays are ordered sets of value elements that begin with a left bracket (“[”) and end with a right bracket (“]”). The value elements in an array are separated by commas. Value elements may be character strings, numbers, Boolean values, or null values, as well as objects or arrays (thus enabling the recursive hierarchical nesting). The key of a key-value pair element is also a character string. Any amount of whitespace can be placed between these items.

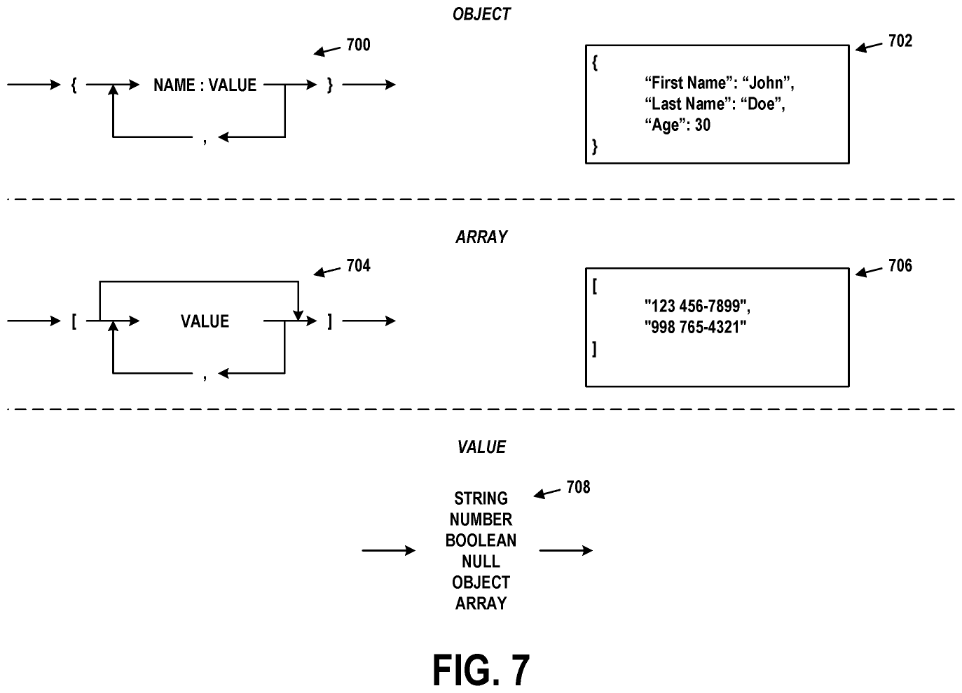

FIG. 7 depicts formal language definitions and associated examples of JSON. Diagram 700 provides a formal definition of an object, diagram 704 provides a formal definition of an array, and diagram 708 provides a formal definition of a value element. Example 702 is of an object containing three key-value pair elements for the first name, last name and age, respectively, of an individual. Example 706 is of an array containing two value elements for phone numbers. Both of these examples are fully encapsulated by braces and brackets, respectively. Thus, they are completely defined and may be referred to as records. In other words, records in JSON files are delimited by an open brace and a corresponding close brace, or an open bracket and a corresponding close bracket. Objects, arrays, values, and/or any combination thereof may be referred to as elements. A particular arrangement of objects, arrays and/or values may be referred to as a schema.

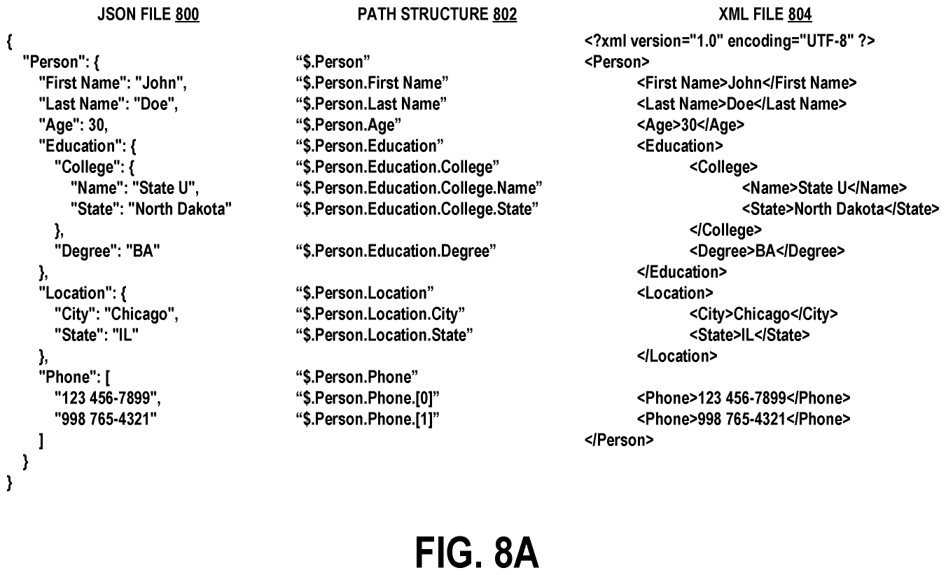

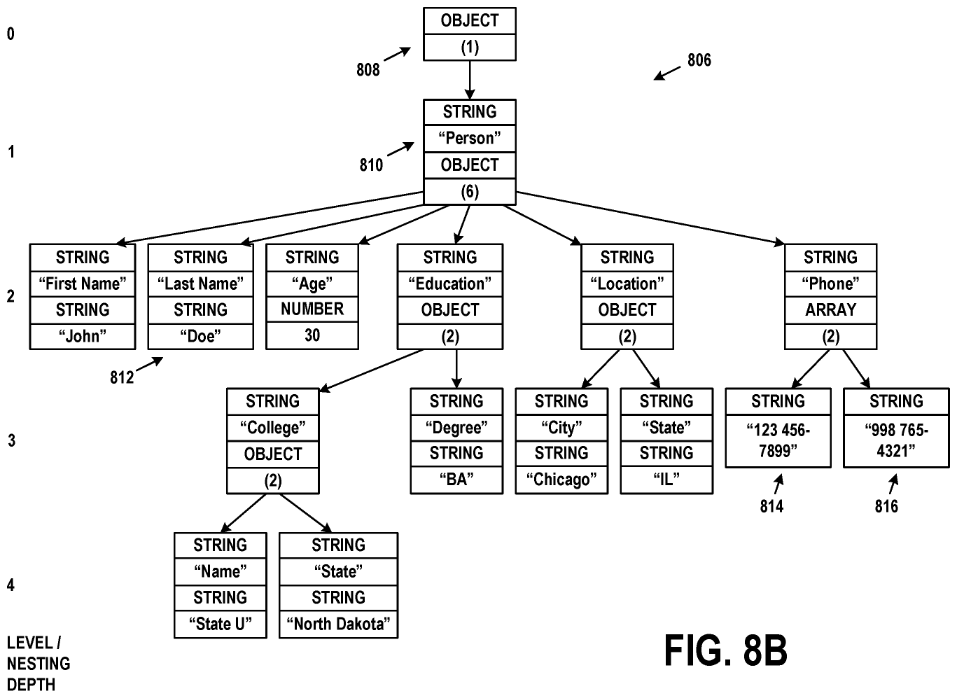

Elements within a record can be uniquely identified by a path. The path may be represented as a concatenation of the nested objects and arrays that can be used to locate a specific element within the JSON file. For instance, in FIG. 8A, JSON file 800 defines a “Person” object with various nested objects and arrays. Path structure 802 defines the corresponding paths for each, object, array, and value in JSON file 800. For instance, the person's first name (“John”) can be found at “$.Person.First Name”, the person's age (30) can be found at “$.Person.Age” and the person's degree (“BA”) can be found at “$.Person.Education.Degree”. In this syntax, a path always begins with “$.” and element names (keys) are separated by a “.”. Further, arrays are indexed in brackets surrounding numbering that begins at 0 (e.g., “$.Person.Phone.[0]” and “$.Person.Phone.[1]”).

For sake of illustration, FIG. 8A also includes XML file 804, which is functionally equivalent to JSON file 800, and when parsed would also result in path structure 802. XML file 804 demonstrates that the embodiments herein can operate equally well on XML and other structured data formats.

FIG. 8B depicts a DOM representation 806 of JSON file 800 (and XML file 804). In particular, DOM representation 806 is in a tree form, each node of which represents an element of JSON file 800. There is a one-to-one-to-one mapping between elements in JSON file 800, their paths, and nodes in DOM representation 806.

Primitives are represented in leaf nodes with key-value pairs. For example, node 812 represents the key-value pair of “Last Name”: “Doe” from JSON file 800. The exception is that elements of an array, such as those represented by nodes 814 and 816, contain only values.

Objects and arrays are represented as non-leaf (intermediate) nodes with keys therein and values that refer to one or more child nodes. For example, node 808 represents the entire object encoded by JSON file 800, notably the information between the outermost pair of braces. As these braces contain a single object, node 808 indicates such and has a single child, node 810. Node 810, on the other hand, represents the “Person” object which has 6 elements. Thus, node 810 has six children, one for each of these elements.

To the left of DOM representation 806 is a labeling of the levels in the tree. These levels represent the depth of the nodes, which is related to the nesting depth of the elements. For example, node 808 is at level 0 (no ancestor elements), node 810 is at level 1 (1 ancestor element), node 812 is at level 2 (2 ancestor elements), nodes 814 and 816 are at level 3 (3 ancestor elements), and so on. These levels map to sections of the paths in path structure 802. For example, level 0 maps to “$”, level 1 maps to “Person”, level 2 maps to “$.Person.First Name”, “$.Person.Last Name”, “$.Person.Age”, “$.Person.Education”, “$.Person.Location”, “$.Person.Phone”, and so on.

The embodiments of FIGS. 8A and 8B are for purpose of example. Different structured data formats, with different arrangements of paths, tags, terms, and so on may be used.

### VII. EXAMPLE TAXONOMY NORMALIZATION

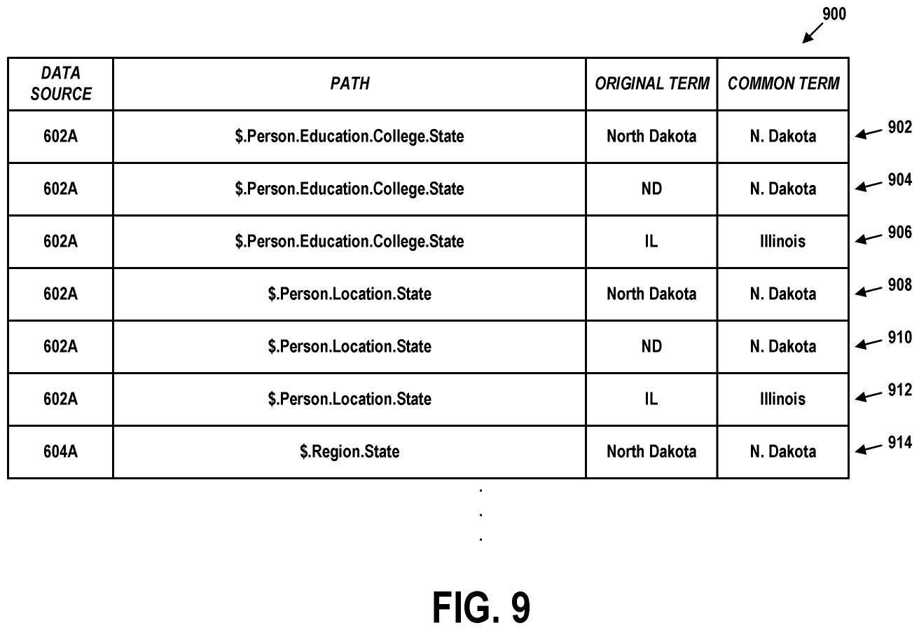

FIG. 9 depicts table 900 that can be used as at least part of common taxonomy 614. Particularly, FIG. 9 includes a set of entries that associate a data source, a path within the structured data provided by that data source, an original term that would appear in or is otherwise linked to the path, and a common term to which the original term is to be translated. Sometimes, the common terms alone may be referred to as the common taxonomy. For sake of consistency and purpose of example, the paths and terms in table 900 relate to the example structured data of FIG. 8A.

The data source field identifies which data source provides data in accordance with the entry. In the context of architecture 610, this could be one of data sources 602A, 602B, or 602C. The path field specifies the path within the structured data in which the original term is disposed. The paths in table 900 are consistent with path structure 802, and can also be determined through a traversal of DOM representation 806. The original term is the value that appears at a location in the structured data specified by the corresponding path. The common term is a term in the common taxonomy to which the corresponding original term is to be translated.

In some cases (not shown in FIG. 9), the common term may also have an associated path, and normalization procedures may translate original paths and terms to common versions thereof. Thus, translations from one structured data schema to another may be supported.

As examples, entries 902 and 904 associate original terms appearing in the path “$.Person.Education.College.State” and referring to the U.S. state of North Dakota to the common term “N. Dakota”. Likewise, entry 906 associates original term “IL” to common term “Illinois”. Entries 908, 910, and 912 have similar associations for the same original terms when they appear in the path “$.Person.Location. State”.

Each of entries 902, 904, 906, 908, 910, and 912 are for data that comes from data source 602A. In contrast, entry 914 is for data that comes from data source 604A. In this entry, an original term “North Dakota” that appears in the path “$.Region.State” is associated with the common term “N. Dakota”. This shows that taxonomy normalization can be configured to accommodate various structured data schema and/or formats formats used by the data sources.

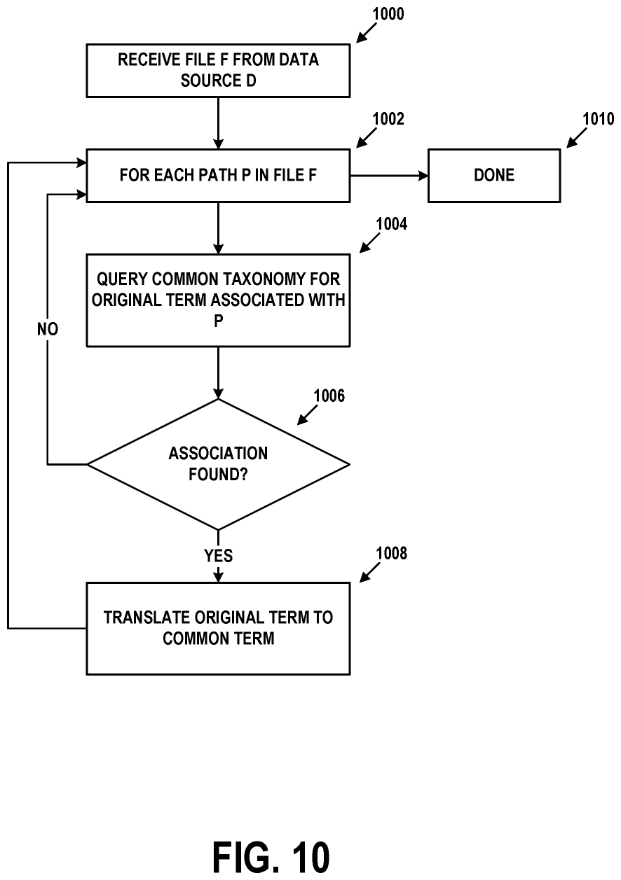

The entries of table 900 can be used in various ways to facilitate taxonomy normalization. One example is provided in FIG. 10. In particular, FIG. 10 depicts a flow chart for translating original terms in structured data received from a data source to common terms of a common taxonomy. The operations of this flow chart may be carried out by a computational instance of remote network management platform 320, for example.

Block 1000 may involve receiving a file F from a data source D. Text within file F may be arranged in accordance with a structured data format (e.g., JSON, XML, or YAML) and may include a number of paths.

Block 1002 may involve initiating a “for each” loop that iterates over each path P in file F. Blocks 1004, 1006, and 1008 may appear in the body of the “for each” loop. If there are no more paths to consider in the loop (i.e., all paths have been considered), control passes to block 1010.

Block 1004 may involve querying a common taxonomy for an original term specified in path P of file F. The common taxonomy may be, for example, represented by table 900. Thus, given a path and its associated original term, this path and term are looked up in a table such as table 900.

Block 1006 may involve determining whether an entry in table 900 specifying path P and its associated original term is found. If such an entry is not found, control passes back to block 1002 and the next path (if any) in file F is processed. If such an entry is found, control passes to block 1008.

Block 1008 may involve translating the original term into the common term in accordance with the entry. For example, if path P is “$.Person.Education.College.State” and the original term is “North Dakota”, entry 902 may be used to translate the original term to “N. Dakota”.

In some embodiments, this translation may change the original term into the common term in file F or in a DOM representation of file F, for example. In other embodiments, a tag or key-value pair may be added to path P to indicate the common term while leaving the original term in place. Additional possibilities exist.

Block 1010 is labeled “done” but should not be interpreted to imply that all processing end when it is reached. Instead, parsing of file F (or its associated DOM representation) may be complete, but other operations may take place. For instance, triggers for one or more actions may be checked to determine when the corresponding actions should be performed.

Illustrative examples follow for vulnerability response and risk management applications. Other types of applications may also use taxonomy normalization.

Vulnerabilities may be defects in hardware, operating systems, and/or software packages that can be exploited to gain unauthorized access to certain information on the managed network or to cause one or more components of the managed network to behave in an undesirable fashion. A vulnerability response application may receive definitions of vulnerabilities from one or more sources (e.g., vendors, governmental entities, or other third parties), and incorporate these definitions into a vulnerability analysis framework that can identify any such vulnerabilities on a managed network and recommend or carry out remedial action.

Since vulnerability definitions may be received from multiple data sources in a number of different formats, taxonomy normalization can be advantageous. For example, these data sources may refer to a MICROSOFT® WINDOWS® operating system as “Windows”, “Windows 10”, or “MS Windows”. These original terms may be translated to the common term “Microsoft Windows”, for example.

The common term may be used, at least in part, as a trigger for one or more actions. For instance, a report of a critical vulnerability in a version of the operating system that is deployed on the managed network may trigger two actions—one that pushes installation of an upgrade to computers on the managed network that are using the vulnerable version of the operating system, and another that waits 12 hours then causes discovery procedures to inventory the managed network for computers that have not yet been upgraded.

Risk management applications may receive information from financial, healthcare, or regulatory agencies regarding standards under which an enterprise may operate. Based on this information, the enterprise may provide parts of the information to its employees, or change its operations or workflows, as just some examples. Like vulnerability response information, risk management information may be received from multiple data sources in a number of different formats, so taxonomy normalization can be advantageous.

Suppose that a new law or regulation requires that all employees residing in California have to fill out a certain consent form by a particular date. A third-party provider may supply this information to a risk management application. The information may include a description of the law or regulation, and accompanying structured data may include a URL of an online version of the consent form, and indicate the law or regulation applies to California. Since California may be referred to with original terms such as “California”, “CA”, or “Calif” for example, the risk management application may normalize all of these terms to the common term of “CA”.

The common term may be used, at least in part, as a trigger for one or more actions. For instance, an action may cause the computational instance of the enterprise to transmit an email containing the URL to each enterprise employee with a home address in California, and ask those employees to fill out the form.

### VIII. CONFIGURATION OF TAXONOMY NORMALIZATION FOR DATA SOURCES

A computational instance of remote network management platform 320 may support configuring normalized terms for one or more data sources as integrations with these data sources are added to the computational instance, or after the integrations have been added. These configurations may take place by way of a graphical user interface. The graphical user interface may be provided by configurator 616.

Graphical user interface 1100 of FIG. 11 provides an example of how normalized terms can be configured. Particularly, graphical user interface 1100 contains two panes, 1102, and 1106. Pane 1102 includes selection menu 1104 for the original structured data format and terms of a data source, and pane 1106 includes selection menu 1108 for the common, normalized format and terms used by the application.

Notably, selection menu 1104 represents, as the original format, the structured format of FIG. 8A as a nested arrangement of dropdown elements. Selection menu 1108 represents, as the common format, a different arrangement of dropdown elements. This side-by-side arrangement allows the user to easily associate a path in the original format to a path in the common format, and then associate corresponding terms of each.

To that point, element 1110 is shown as selected in selection menu 1104 and element 1112 is shown as selected in selection menu 1108. Choosing a pair of elements in this fashion may form an association between their respective paths, and cause popup window 1114 to appear. Popup window 1114 may prompt the user to enter an association between original and common terms. In FIG. 11, the original (from) term is “California” and the common (to) term is “CA”. In some embodiments, multiple such associations could be entered into popup window 1114.

As shown, the example of graphical user interface 1100 indicates that the user is associating the path “$.Person.Location.State” in structured data received from a data source to the path “$.Employee.Home Address. State” in a common structured data format stored in the computational instance. Further, the example of graphical user interface 1100 also indicates that the user is associating the original term “California” to the common term “CA” in cases where “California” appears in the path “$.Person.Location.State” in structured data received from the data source. In this manner, associations are easily created and edited.

### IX. EXAMPLE OPERATIONS

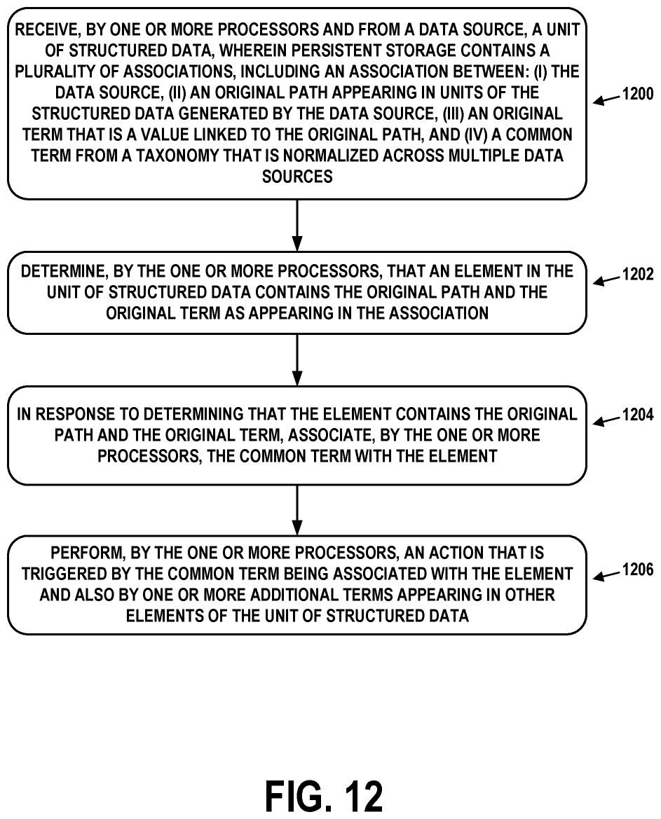

FIG. 12 is a flow chart illustrating an example embodiment. The process illustrated by FIG. 12 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 12 may be simplified by the removal of any one or more of the features shown therein. Further, these embodiments may be combined with features, aspects, and/or implementations of any of the previous figures or otherwise described herein.

Block 1200 may involve receiving, by one or more processors and from a data source, a unit of structured data, wherein persistent storage contains a plurality of associations, including an association between: (i) the data source, (ii) an original path appearing in units of the structured data generated by the data source, (iii) an original term that is a value linked to the original path, and (iv) a common term from a taxonomy that is normalized across multiple data sources.

Block 1202 may involve determining, by the one or more processors, that an element in the unit of structured data contains the original path and the original term as appearing in the association.

Block 1204 may involve, perhaps in response to determining that the element contains the original path and the original term, associating, by the one or more processors, the common term with the element.

Block 1206 may involve performing, by the one or more processors, an action that is triggered by the common term being associated with the element and also by one or more additional terms appearing in other elements of the unit of structured data.

The additional terms may be other original terms and/or other common terms. Embodiments may be configured to, when these other original terms and/or other common terms appear in combination with the common term, trigger the action.

In some embodiments, the persistent storage also includes a second association between: (i) a second data source, (ii) a second original path appearing in units of further structured data generated by the second data source, (iii) a second original term that is a further value linked to the second original path, and (iv) the common term. These embodiments may further involve: receiving, from the second data source, a second unit of the further structured data; determining that a second element in the second unit of the further structured data contains the second original path and the original term as appearing in the second association; possibly in response to determining that the second element contains the second original path and the original term, associating the common term with the second element; and performing the action, wherein the action is also triggered by the common term being associated with the second element and also by one or more additional terms appearing in other elements of the second unit of the structured data.

In some embodiments, the persistent storage also includes a second association between: (i) the data source, (ii) a second original path appearing in the units of structured data generated by the data source, (iii) a second original term that is a further value linked to the second original path, and (iv) a second common term. These embodiments may further involve: receiving, from the data source, a second unit of the structured data; determining that a second element in the second unit of the structured data contains the second original path and the second original term as appearing in the second association; possibly in response to determining that the second element contains the second original path and the second original term, associating the second common term with the second element; and performing a second action that is triggered by the second common term being associated with the second element and also by one or more additional terms appearing in other elements of the unit of the structured data.

In some embodiments, associating the common term with the element comprises appending the common term to the element.

In some embodiments, associating the common term with the element comprises translating the original term into the common term.

In some embodiments, the association in the persistent storage also includes a common path for the taxonomy, wherein the common term is a further value linked to the common path.

In some embodiments, the units of structured data are formatted in accordance with XML, JSON, YAML, or CSV.

In some embodiments, performing the action involves changing state of data in the persistent storage that is related to the unit of structured data, transmitting a message to one or more users related to the unit of structured data, or initiating a workflow related to the unit of structured data.

In some embodiments, the original path defines a sequence of nested elements in the units of structured data.

In some embodiments, the unit of the structured data is represented as a DOM tree.

Some embodiments may involve: generating, for display on a client device, a representation of a graphical user interface containing a first layout of a schema of the structured data generated by the data source and a second layout of a common schema for structured data, wherein elements of the first layout and elements of the second layout are selectable; transmitting, to the client device, the representation of the graphical user interface; receiving, from the client device, a selection of a first element of the first layout and a second element of the second layout; determining the original path, the original term, and the common term from the first element and the second element; and writing the association into the plurality of associations based on the data source, the original path, the original term, and the common term.

### X. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing a plurality of associations, including an association between:
(i) a data source, (ii) an original path appearing in units of structured data generated by the data source, (iii) an original term that is a value linked to the original path, and (iv) a common term from a taxonomy that is normalized across multiple data sources; and
one or more processors configured to:
receive, from the data source, a unit of the structured data;
determine that an element in the unit of the structured data contains the original path and the original term as appearing in the association;
in response to determining that the element contains the original path and the original term, associate the common term with the element; and
perform an action that is triggered by the common term being associated with the element and also by one or more additional terms appearing in other elements of the unit of the structured data.

2. The system of claim 1, wherein the persistent storage also includes a second association between: (i) a second data source, (ii) a second original path appearing in units of further structured data generated by the second data source, (iii) a second original term that is a further value linked to the second original path, and (iv) the common term, and wherein the one or more processors are further configured to:
receive, from the second data source, a second unit of the further structured data;
determine that a second element in the second unit of the further structured data contains the second original path and the original term as appearing in the second association;
in response to determining that the second element contains the second original path and the original term, associate the common term with the second element; and
perform the action, wherein the action is also triggered by the common term being associated with the second element and also by one or more additional terms appearing in other elements of the second unit of the structured data.

3. The system of claim 1, wherein the persistent storage also includes a second association between: (i) the data source, (ii) a second original path appearing in the units of structured data generated by the data source, (iii) a second original term that is a further value linked to the second original path, and (iv) a second common term, and wherein the one or more processors are further configured to:
receive, from the data source, a second unit of the structured data;
determine that a second element in the second unit of the structured data contains the second original path and the second original term as appearing in the second association;
in response to determining that the second element contains the second original path and the second original term, associate the second common term with the second element; and
perform a second action that is triggered by the second common term being associated with the second element and also by one or more additional terms appearing in other elements of the unit of the structured data.

4. The system of claim 1, wherein associating the common term with the element comprises appending the common term to the element.

5. The system of claim 1, wherein associating the common term with the element comprises translating the original term into the common term.

6. The system of claim 1, wherein the association in the persistent storage also includes a common path for the taxonomy, wherein the common term is a further value linked to the common path.

7. The system of claim 1, wherein the units of structured data are formatted in accordance with extensible markup language (XML), JavaScript Object Notation (JSON), Yet Another Markup Language (YAML), or comma-separated-values (CSV).

8. The system of claim 1, wherein performing the action involves changing state of data in the persistent storage that is related to the unit of structured data, transmitting a message to one or more users related to the unit of structured data, or initiating a workflow related to the unit of structured data.

9. The system of claim 1, wherein the original path defines a sequence of nested elements in the units of structured data.

10. The system of claim 1, wherein the unit of the structured data is represented as a document object model (DOM) tree.

11. The system of claim 1, wherein the one or more processors are further configured to:
generate, for display on a client device, a representation of a graphical user interface containing a first layout of a schema of the structured data generated by the data source and a second layout of a common schema for structured data, wherein elements of the first layout and elements of the second layout are selectable;
transmit, to the client device, the representation of the graphical user interface;
receive, from the client device, a selection of a first element of the first layout and a second element of the second layout;
determine the original path, the original term, and the common term from the first element and the second element; and
write the association into the plurality of associations based on the data source, the original path, the original term, and the common term.

12. A computer-implemented method comprising:
receiving, by one or more processors and from a data source, a unit of structured data, wherein persistent storage contains a plurality of associations, including an association between: (i) the data source, (ii) an original path appearing in units of the structured data generated by the data source, (iii) an original term that is a value linked to the original path, and (iv) a common term from a taxonomy that is normalized across multiple data sources;
determining, by the one or more processors, that an element in the unit of structured data contains the original path and the original term as appearing in the association;
in response to determining that the element contains the original path and the original term, associating, by the one or more processors, the common term with the element; and
performing, by the one or more processors, an action that is triggered by the common term being associated with the element and also by one or more additional terms appearing in other elements of the unit of structured data.

13. The computer-implemented method of claim 12, wherein the persistent storage also includes a second association between: (i) a second data source, (ii) a second original path appearing in units of further structured data generated by the second data source, (iii) a second original term that is a further value linked to the second original path, and (iv) the common term, the computer-implemented method further comprising:
receiving, from the second data source, a second unit of the further structured data;
determining that a second element in the second unit of the further structured data contains the second original path and the original term as appearing in the second association;
in response to determining that the second element contains the second original path and the original term, associating the common term with the second element; and
performing the action, wherein the action is also triggered by the common term being associated with the second element and also by one or more additional terms appearing in other elements of the second unit of the structured data.

14. The computer-implemented method of claim 12, wherein the persistent storage also includes a second association between: (i) the data source, (ii) a second original path appearing in the units of structured data generated by the data source, (iii) a second original term that is a further value linked to the second original path, and (iv) a second common term, the computer-implemented method further comprising:
receiving, from the data source, a second unit of the structured data;
determining that a second element in the second unit of the structured data contains the second original path and the second original term as appearing in the second association;
in response to determining that the second element contains the second original path and the second original term, associating the second common term with the second element; and
performing a second action that is triggered by the second common term being associated with the second element and also by one or more additional terms appearing in other elements of the unit of the structured data.

15. The computer-implemented method of claim 12, wherein associating the common term with the element comprises appending the common term to the element.

16. The computer-implemented method of claim 12, wherein associating the common term with the element comprises translating the original term into the common term.

17. The computer-implemented method of claim 12, wherein the association also includes a common path for the taxonomy, wherein the common term is a further value linked to the common path.

18. The computer-implemented method of claim 12, wherein performing the action involves changing state of data in the persistent storage that is related to the unit of structured data, transmitting a message to one or more users related to the unit of structured data, or initiating a workflow related to the unit of structured data.

19. The computer-implemented method of claim 12, wherein the original path defines a sequence of nested elements in the units of structured data.

20. An article of manufacture including a non-transitory computer-readable medium, having stored thereon program instructions that, upon execution by a computing system, cause the computing system to perform operations comprising:
receiving, from a data source, a unit of structured data, wherein persistent storage contains a plurality of associations, including an association between: (i) the data source, (ii) an original path appearing in units of structured data generated by the data source, (iii) an original term that is a value linked to the original path, and (iv) a common term from a taxonomy that is normalized across multiple data sources;
determining that an element in the unit of the structured data contains the original path and the original term as appearing in the association;
in response to determining that the element contains the original path and the original term, associating the common term with the element; and
performing an action that is triggered by the common term being associated with the element and also by one or more additional terms appearing other elements of the unit of the structured data.
